(19) United States
(12) Patent Application Publication
(10) Pub. No.: US 2025/0286613 A1
(43) Pub. Date: Sep. 11, 2025

(54) DETECTING RADIO LINK FAILURE IN IOT NTN

(71) Applicant: Telefonaktiebolaget LM Ericsson (publ), STOCKHOLM (SE)

(72) Inventors: Emre Yavuz, STOCKHOLM (SE); Johan Rune, LIDINGÖ (SE); Helka-Liina Määttänen, ESPOO (FI); Jonas Sedin, BRENTFORD Greater London (GB); Xingqin Lin, SAN JOSÈ, CA (US)

(21) Appl. No.: 18/554,548

(22) PCT Filed: Apr. 11, 2022
(86) PCT No.: PCT/IB2022/053393

§ 371 Date: Oct. 9, 2023

Related U.S. Application Data
(60) Provisional application No. 63/173,141, filed on Apr. 9, 2021.

(51) Int. Cl. H04B 7/185

(52) U.S. Cl. CPC H04B 7/18539; H04B 7/1851; H04B 7/18545

(57) ABSTRACT

According to some embodiments, a method is performed by a wireless device capable of operating in a non-terrestrial network (NTN). The method comprises determining an amount of time until a service link or feeder link switch and, based on the determined amount of time, modifying a radio link failure parameter used to determine when to declare a radio link failure (RLF).

### TECHNICAL FIELD

Embodiments of the present disclosure are directed to wireless communications and, more particularly, to detecting radio link failure (RLF) in Internet-of-things (IoT) non-terrestrial networks (NTNs).

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Third Generation Partnership Project (3GPP) specifies technologies such as machine-to-machine (M2M) communication and Internet-of-things (IoT). Enhancements to support machine-type communications (MTC) include new user equipment (UE) categories M1 (Cat-M1) and NB1 (Cat-NB1) to support reduced maximum bandwidth of up to 6 physical resource blocks (PRBs) in eMTC and narrowband carrier in NB-IoT specifying a new radio interface.

Multiple differences exist between “legacy” long term evolution (LTE) and the procedures and channels defined for eMTC or NB-IoT. Some important differences include a new physical downlink control channel, i.e., MPDCCH used in eMTC and NPDCCH used in NB-IoT.

3GPP eMTC, also often referred to as LTE-M, specified the first low-complexity UE category 0 (Cat-0). Cat-0 supports a reduced peak data rate of 1 Mbps, single antenna and half duplex frequency division duplex (HD FDD) operation.

3GPP eMTC also includes the Cat-M1 UE category. It supports a further reduced complexity, and coverage enhanced (CE) operation. The additional cost reduction came from a reduced transmission and reception bandwidth of 1.08 MHz, equivalent to six 180 KHz PRBs. The introduction of a lower UE power class of 20 dBm, in addition to the 23 dBm power class, further facilitates a lower UE complexity.

Because of the reduction in bandwidth, a new narrowband physical downlink control channel, the MTC physical downlink control channel (MPDCCH), was introduced as a substitute for the wideband legacy physical downlink control channel (PDCCH) and the enhanced PDCCH (EPDCCH). The Cat-M1 UEs monitor MPDCCH in a narrowband (NB), which is defined by 6 adjacent PRBs.

3GPP eMTC supports a maximum coupling loss (MCL) that is 20 dB larger than the normal MCL of LTE. This is achieved mainly through time repetition and a relaxed acquisition time of the physical channels and signals. The primary and secondary synchronization signals (PSS and SSS) are fully reused from LTE and extended coverage is achieved by increased acquisition time.

For the physical broadcast channel (PBCH), the MPDCCH, the physical uplink control channel (PUCCH) and the data channels, that is, the physical uplink shared channel (PUSCH) and physical downlink shared channel (PDSCH), the desired coverage enhancement is achieved through time repetition of a transmission block.

In LTE Releases 14 and 15, eMTC was further enhanced to support a more diversified set of applications and services. A new UE category Cat-M2 was specified. The performance of eMTC Release 15 meets the IMT-2020 5G requirements for the massive IoT use case.

3GPP also specifies narrowband IoT (NB-IoT). The objective is to specify a radio access for cellular internet of things that addresses improved indoor coverage, support for massive number of low throughput devices, not sensitive to delay, ultra-low device cost, low device power consumption and (optimized) network architecture.

NB-IoT can be described as a narrowband version of LTE. Similar to eMTC, NB-IoT uses increased acquisition times and time repetitions to extend the system coverage. The repetitions can be seen as a third level of retransmissions added at the physical layer as a complement to those at medium access control (MAC) hybrid automatic repeat request (HARQ) and radio link control (RLC) automatic repeat request (ARQ).

A NB-IoT downlink carrier is defined by 12 orthogonal frequency division multiplexing (OFDM) sub-carriers, each of 15 kHz, giving a total baseband bandwidth of 180 kHz. When multiple carriers are configured, several 180 kHz carriers can be used, e.g., for increasing the system capacity, inter-cell interference coordination, load balancing, etc. This design gives NB-IoT a high deployment flexibility:

NB-IoT supports 3 different deployment scenarios or mode of operations. The first is stand-alone operation, which uses for example the spectrum currently being used by GERAN systems as a replacement of one or more GSM carriers. In principle it operates on any carrier frequency which is neither within the carrier of another system nor within the guard band of another system's operating carrier. The other system can be another NB-IoT operation or any other radio access technology (RAT), e.g., LTE.

The second is guard band operation, which uses the unused resource blocks within an LTE carrier's guard-band. The term guard band may also interchangeably be referred to as guard bandwidth. As an example, for LTE bandwidth of 20 MHz (i.e., Bw1=20 MHz or 100 RBs), the guard band operation of NB-IoT may be placed anywhere outside the central 18 MHZ but within 20 MHz LTE bandwidth.

The third is in-band operation, which uses resource blocks within a normal LTE carrier. The in-band operation may also interchangeably be referred to as in-bandwidth operation. More generally the operation of one RAT within the BW of another RAT is also referred to as in-band operation. As an example, in a LTE bandwidth of 50 RBs (i.e., Bw1=10 MHz or 50 RBs), NB-IoT operation over one resource block (RB) within the 50 RBs is referred to as in-band operation.

NB-IoT defines anchor and non-anchor carriers. In an anchor carrier, the UE assumes that anchor specific signals including NPSS/NSSS/NPBCH/SIB-NB are transmitted on downlink. In a non-anchor carrier, the UE does not assume that NPSS/NSSS/NPBCH/SIB-NB are transmitted on downlink. An anchor carrier is transmitted on at least subframes #0, #4, #5 in every frame and subframe #9 in every other frame. Additional downlink subframes in a frame can also be configured on an anchor carrier by means of a downlink bit map. An anchor carrier transmitting NPBCH/SIB-NB also contains NRS. A non-anchor carrier contains a narrowband reference signal (NRS) during certain occasions and UE specific signals such as NPDCCH and NPDSCH. NRS. NPDCCH and NPDSCH are also transmitted on an anchor carrier. The resources for a non-anchor carrier are configured by the network node.

A non-anchor carrier can be transmitted in any subframe as indicated by a downlink bit map. For example, the eNB signals a downlink bit map of downlink subframes using RRC message (DL-Bitmap-NB) which are configured as non-anchor carrier. The anchor carrier and/or non-anchor carrier may typically be operated by the same network node, e.g., by the serving cell. But the anchor carrier and/or non-anchor carrier may also be operated by different network nodes.

NB-IoT includes radio link monitoring (RLM) procedures. The RLM procedure is described with respect to NB-IoT, but similar aspects apply also to eMTC. The purpose of RLM is to monitor the radio link quality of the serving cell of the user equipment (UE) and use that information to decide whether the UE is in in-sync or out-of-sync with respect to that serving cell.

In LTE, RLM is carried out by UE performing measurement on downlink reference symbols (CRS) in RRC_CONNECTED state. If results of radio link monitoring points at a certain number of consecutive out of sync (OOS) indications, the UE starts the RLF procedure and declares radio link failure (RLF) after the expiry of RLF timer (e.g., T310).

The procedure is carried out by comparing the estimated downlink reference symbol measurements to two thresholds, Qout and Qin. Qout and Qin correspond to a block error rate (BLER) of hypothetical control channel (e.g., NPDCCH) transmissions from the serving cell. Examples of the target BLER corresponding to Qout and Qin are 10% and 2% respectively. The radio link quality in RLM is performed based on reference signal (e.g., NRS), at least once every radio frame (when not configured with discontinuous reception (DRX)) or periodically with DRX cycle (when configured with DRX), over the system bandwidth or control channel bandwidth (e.g., NPDCCH BW) for the UE, or over the UE bandwidth (e.g., 200 kHz).

T310 is also referred to as the RLF timer, which starts when the UE detects physical layer problems for the PCell. More specifically the RLF timer starts upon UE receiving N310 number of consecutive out-of-sync indications from its lower layers. When T310 expires RLF is declared, but T310 is reset upon UE receiving N311 number of consecutive in-sync indications from its lower layers. Upon RLF declaration (i.e., T310 expiration) the UE starts radio resource control (RRC) connection re-establishment procedure and starts another timer T311.

The RRC connection re-establishment procedure starts with cell selection and T311 is reset if the UE finds and selects a suitable cell and then the UE sends an RRCReestablishementRequest message in the selected cell and starts timer T301. If the RRC connection reestablishment procedure is successful (indicated by an RRCReestablishment message from the gNB), the UE stops/resets timer T301. If T311 expires before (because the UE failed to select a suitable cell), or if T301 expires (because the RRC connection reestablishment failed), then the UE goes to RRC_IDLE state and it may initiate cell selection.

Parameters T310, T311, T301, N310 and N311 are configured by the PCell, e.g., via RRC message. T310 can vary between 0 to 8000 ms. T311 can vary from 1000 ms to 30000 ms. N310 can be set from {1, 2, 3, 4, 6, 8, 10, 20}, and N311 can be set from {1, 2, 3, 4, 5, 6, 8, 10}.

FIG. 1 is a timing diagram illustrating an example of radio link failure (RLF) and radio resource control (RRC) connection re-establishment. As illustrated, the process generally includes RLF detection, cell search, and RRC connection re-establishment.

3GPP also specifies the 5G system (5GS). This is a new generation radio access technology intended to serve use cases such as enhanced mobile broadband (eMBB), ultra-reliable and low latency communication (URLLC) and mMTC. 5G includes the new radio (NR) access stratum interface and the 5G Core Network (5GC). The NR physical and higher layers reuse parts of the LTE specification, and to that add needed components when motivated by the new use cases. One such component is a sophisticated framework for beam forming and beam management to extend the support of the 3GPP technologies to a frequency range going beyond 6 GHz.

In 3GPP release 15, 3GPP started the work to prepare NR for operation in a non-terrestrial network (NTN) (e.g., satellite communications). The work was performed within the study item “NR to support Non-Terrestrial Networks” and resulted in TR 38.811. In 3GPP release 16, the work to prepare NR for operation in an NTN network continued with the study item “Solutions for NR to support Non-Terrestrial Network”. In parallel the interest to adapt NB-IoT and LTE-M for operation in NTN is growing. As a consequence, 3GPP release 17 contains both a work item on NR NTN and a study item on NB-IoT and LTE-M support for NTN.

A satellite radio access network usually includes the following components: a satellite that refers to a space-borne platform; an earth-based gateway that connects the satellite to a base station or a core network, depending on the choice of architecture; a feeder link that refers to the link between a gateway and a satellite; and an access link that refers to the link between a satellite and a UE.

Depending on the orbit altitude, a satellite may be categorized as low earth orbit (LEO), medium earth orbit (MEO), or geostationary earth orbit (GEO) satellite. LEO includes typical heights ranging from 250-1,500 km, with orbital periods ranging from 90-120 minutes. MEO includes typical heights ranging from 5,000-25,000 km, with orbital periods ranging from 3-15 hours. GEO includes height at about 35,786 km, with an orbital period of 24 hours.

The significant orbit height means that satellite systems are characterized by a path loss that is significantly higher than what is expected in terrestrial networks. To overcome the pathloss it is often required that the access and feeder links are operated in line of sight conditions, and that the UE is equipped with an antenna offering high beam directivity.

A communication satellite typically generates several beams over a given area. The footprint of a beam is usually in an elliptic shape, which has been traditionally considered as a cell. The footprint of a beam is also often referred to as a spotbeam. The footprint of a beam may move over the earth surface with the satellite movement or may be earth fixed with some beam pointing mechanism used by the satellite to compensate for its motion. The size of a spotbeam depends on the system design, which may range from tens of kilometers to a few thousands of kilometers.

Two basic architectures have been considered. One is the transparent payload (also referred to as bent pipe architecture). In this architecture, the gNB is located on the ground and the satellite forwards signals/data between the gNB and the UE. Another is the regenerative payload. In this architecture the gNB is located in the satellite. In the work item for NR NTN in 3GPP release 17, only the transparent architecture is considered.

FIG. 2 illustrates an example architecture of a satellite network with bent pipe transponders. The gNB may be integrated in the gateway or connected to the gateway via a terrestrial connection (e.g., wire, optic fiber, wireless link).

The NTN beam may in comparison to the beams observed in a terrestrial network be very wide and cover an area outside of the area defined by the served cell. Beam covering adjacent cells will overlap and cause significant levels of intercell interference. To overcome the large levels of interference, a typical approach in a NTN is to configure different cells with different carrier frequencies and polarization modes.

In a LEO NTN, the satellites are moving with a very high velocity. This leads to a Doppler shift of the carrier frequency on the service link of up to 24 ppm for a LEO satellite at 600 km altitude. The Doppler shift is also time variant due to the satellite motion over the sky. The Doppler shift may vary with up to 0.27 ppm/s for a LEO 600 km satellite. The Doppler shift will impact, i.e., increase or decrease, the frequency received on the service link compared to the transmitted frequency. For GEO NTN, the satellites may move in an orbit inclined relative to the plane of the equator. The inclination introduces a periodic movement of the satellite relative earth which introduces a predictable, and daily periodically repeating Doppler shift of the carrier frequency as exemplified in FIG. 3.

The terms beam and cell may be used interchangeably herein, unless explicitly noted otherwise. Although particular embodiments and examples are described with respect to NTN in the context of IoT, the embodiments and examples apply to any wireless network dominated by line of sight conditions.

TR 38.821 instructs that ephemeris data may be provided to the UE, for example, to assist with pointing a directional antenna (or an antenna beam) towards a satellite. A UE that knows its own position, e.g., based on GNSS, may also use the ephemeris data to calculate correct timing advance (TA) and Doppler shift.

A satellite orbit can be fully described using 6 parameters. Which set of parameters is chosen can be decided by the user; many different representations are possible. For example, a choice of parameters used often in astronomy is the set (a, ε, i, Ω, ω, t). Here, the semi-major axis a and the eccentricity ε describe the shape and size of the orbit ellipse; the inclination i, the right ascension of the ascending node Ω, and the argument of periapsis ω determine its position in space, and the epoch t determines a reference time (e.g., the time when the satellites moves through periapsis). This set of parameters is illustrated in FIG. 4.

A two-line element set (TLE) is a data format encoding a list of orbital elements of an Earth-orbiting object for a given point in time, the epoch. As an example of a different parametrization, TLEs use mean motion n and mean anomaly M instead of a and t.

A completely different set of parameters is the position and velocity vector (x, y, z, vₓ, v_{y}, v_{z}) of a satellite. These are sometimes referred to as orbital state vectors. They can be derived from the orbital elements and vice versa because the information they contain is equivalent. All these formulations (and many others) are possible choices for the format of ephemeris data to be used in NTN.

It is important that a UE can determine the position of a satellite with accuracy of at least a few meters. However, several studies have shown that this might be hard to achieve when using the de-facto standard of TLEs. On the other hand, LEO satellites often have GNSS receivers and can determine their position with some meter level accuracy.

Another item captured in TR 38.821 is the validity time of ephemeris data. Predictions of satellite positions in general degrade with increasing age of the ephemeris data used, due to atmospheric drag, maneuvering of the satellite, imperfections in the orbital models used, etc. Therefore, the publicly available TLE data are updated quite frequently, for example. The update frequency depends on the satellite and its orbit and ranges from weekly to multiple times a day for satellites on very low orbits which are exposed to strong atmospheric drag and need to perform correctional maneuvers often.

While it may be possible to provide the satellite position with the required accuracy, care needs to be taken to meet these requirements, e.g., when choosing the ephemeris data format, or the orbital model to be used for the orbital propagation.

Ephemeris data consists of at least 5 parameters describing the shape and position in space of the satellite orbit. It also comes with a timestamp, which is the time when the other parameters describing the orbit ellipse were obtained. The position of the satellite at any given time in the nearer future can be predicted from this data using orbital mechanics. The accuracy of the prediction will, however, degrade for projections further and further into the future. The validity time of a certain set of parameters depends on many factors such as the type and altitude of the orbit, but also the desired accuracy, and ranges from the scale of a few days to a few years.

There currently exist certain challenges. For example, the following are several challenges that need to be addressed when evolving cellular IoT technologies such as eMTC and NB-IoT to support NTN: moving satellites (resulting in moving cells or switching cells), long propagation delays, and large Doppler shifts.

Moving satellites result in moving or switching cells. The default assumption in terrestrial network design, e.g. NR or LTE, is that cells are stationary. This is not the case in NTN, especially when LEO satellites are considered. A LEO satellite may be visible to a UE on the ground only for a few seconds or minutes. There are two different options for LEO deployment. The beam/cell coverage is fixed with respect to a geographical location with earth-fixed beams, i.e., steerable beams from satellites ensure that a certain beam covers the same geographical area even as the satellite moves in relation to the surface of the earth. On the other hand, with moving beams a LEO satellite has a fixed antenna pointing direction in relation to the earth's surface, e.g., perpendicular to the earth's surface, and thus cell/beam coverage sweeps the earth as the satellite moves. In that case, the spotbeam, which is serving the UE, may switch every few seconds.

Another problem is long propagation delays. The propagation delays in terrestrial mobile systems are usually less than 1 millisecond. In contrast, the propagation delays in NTN can be much longer, ranging from several milliseconds (LEO) to hundreds of milliseconds (GEO) depending on the altitudes of the spaceborne or airborne platforms deployed in the NTN.

Another problem is large Doppler shifts. The movements of the spaceborne or airborne platforms deployed in NTN may result in large Doppler shifts. For example, a LEO satellite at the height of 600 km can lead to a time-varying Doppler shift as large as 24 ppm.

Yet another challenge related to the moving satellite aspect described above is that when the responsibility for covering a certain geographical cell area in the earth fixed beam case switches from one satellite to another, preferably with a short period of overlap (i.e., both the old and the new satellite cover the cell area simultaneously), this may be assumed to involve a cell change, e.g. change of PCI, which means that all UEs in connected mode that are served by the old cell (to/via the old satellite) are handed over to the new cell (and the new satellite) in a short time (i.e., the period of overlap), which may cause a high load peak on random access channel (RACH) resources, random access processing resources and processing resources for handover preparation associated with the new cell. If these resources are overloaded, the consequences may involve, e.g., extended interruption times, handover and radio link failures.

3GPP has investigated the mobility procedures to find solutions to address the problems that may occur due to the challenges mentioned above for NTN with the motivation to reduce service interruption during handover due to large propagation delay and high handover rates, to introduce mechanisms to improve handover robustness due to small signal strength variation in regions of beam overlap, and to compensate for propagation delay differences in the UE measurement windows between cells/beams originating from different satellites. This is especially the case for LEO NTN. The investigation included aspects related to additional triggering conditions for conditional handover mechanism, adaptation of measurement-based thresholds and events, mobility related configuration, measurement configuration/reporting, and service continuity for mobility between TN and NTN.

Considering the large cell sizes in non-terrestrial networks, it may be difficult for the source eNB/gNB to send HO commands to a large number of UEs in a short time. A group of such UEs may not be able to perform HO on time; as a result, radio link failure may be detected and UEs initiate the RRC re-establishment procedure. Restoring the RRC connection may take a long time considering that it involves not only the RRC re-establishment procedure but also the time it takes for the RLF detection and the cell selection and on top of that the long propagation delays during the message exchange. It is also possible that re-establishment procedure may fail. In short, this has an impact on service continuity.

Note that in NB-IoT there is no support for mobility, therefore only RLF would be triggered in connected mode followed by RRC re-establishment. The UE will search for a cell after RLF is declared to initiate the RRC connection re-establishment procedure. This procedure is used for both user plane, e.g., RRC resume, and control plane, e.g., DoNAS, solutions and it facilitates retrieval of UE context and recovery of undelivered data.

### SUMMARY

Based on the description above, certain challenges currently exist when evolving cellular Internet-of-things (IoT) technologies, such as enhanced machine type communication (eMTC) and narrowband IoT (NB-IoT), to support non-terrestrial networks (NTNs). Certain aspects of the present disclosure and their embodiments may provide solutions to these or other challenges. Particular embodiments reduce the time taken to declare radio link failure (RLF) in IoT non-terrestrial networks. Particular embodiments provide information to the user equipment (UE) (e.g., guidance regarding when to declare RLF) so that radio link failure can be declared earlier when the UE is not expected to get back in-sync. The overall service interruption is shorter when compared to legacy operation.

According to some embodiments, a method is performed by a wireless device capable of operating in a NTN. The method comprises determining an amount of time until a service link or feeder link switch and, based on the determined amount of time, modifying a radio link failure parameter used to determine when to declare a RLF.

In particular embodiments, determining the amount of time until a service link or feeder link switch is based on an elevation angle of a satellite associated with the service link or feeder link. The elevation angle of the satellite is in relation to the wireless device and/or is in relation to a center of a cell served by the satellite.

In particular embodiments, determining the amount of time until a service link or feeder link switch is based on an expected time to be served, is based on a position of the wireless device in a cell, an/or is based on an overlap period between a first satellite and a second satellite.

In particular embodiments, modifying the radio link failure parameter comprises modifying at least one of an out of synchronization counter and an in synchronization counter, modifying a RLF timer, and/or modifying a RLF threshold.

According to some embodiments, a wireless device comprises processing circuitry operable to perform any of the methods of the wireless device described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method is performed by a network node capable of operating in an NTN. The method comprises transmitting a radio link failure configuration to a wireless device. The radio link failure configuration comprises any one or more of: a threshold value representing a time until a service link or feeder link switch; a value or scaling factor for an out of synchronization counter; a value or scaling factor for an in synchronization counter; a value or scaling factor for a RLF timer; and/or a value or scaling factor for a RLF threshold.

In particular embodiments, the threshold value representing a time until a service link or feeder link switch is based on one or more of an elevation angle of a satellite, a position of the wireless device in a cell and an overlap period between a first satellite and a second satellite.

According to some embodiments, a network node network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments reduce the overall service interruption compared to legacy operation by reducing the time it takes to declare RLF. RLF followed by RRC connection re-establishment may also be beneficial as an alternative to handover when the handover procedure cannot be performed by a large number of UEs during a service or feeder link switch.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a timing diagram illustrating an example of radio link failure (RLF) and radio resource control (RRC) connection re-establishment;

FIG. 2 illustrates an example architecture of a satellite network with bent pipe transponders;

FIG. 3 is a graph illustrating an example of the diurnal Doppler shift of the forward service link observed for a GEO satellite operating from an inclined orbit;

FIG. 4 illustrates orbital elements for describing a satellite orbit;

FIG. 5 illustrates scaling of RLF metrics based on elevation angle or distance, where in a) the scaling is a continuous linear function of the elevation angle/distance, and in b) the scaling is a step-wise function of the elevation angle/distance;

FIG. 6 is a block diagram illustrating an example wireless network;

FIG. 7 illustrates an example user equipment, according to certain embodiments;

FIG. 8 is flowchart illustrating an example method in a wireless device, according to certain embodiments;

FIG. 9 is a flowchart illustrating an example method in a network node, according to certain embodiments;

FIG. 10 illustrates a schematic block diagram of a wireless device and network node in a wireless network, according to certain embodiments;

FIG. 11 illustrates an example virtualization environment, according to certain embodiments;

FIG. 12 illustrates an example telecommunication network connected via an intermediate network to a host computer, according to certain embodiments;

FIG. 13 illustrates an example host computer communicating via a base station with a user equipment over a partially wireless connection, according to certain embodiments;

FIG. 14 is a flowchart illustrating a method implemented, according to certain embodiments;

FIG. 15 is a flowchart illustrating a method implemented in a communication system, according to certain embodiments;

FIG. 16 is a flowchart illustrating a method implemented in a communication system, according to certain embodiments; and

FIG. 17 is a flowchart illustrating a method implemented in a communication system, according to certain embodiments.

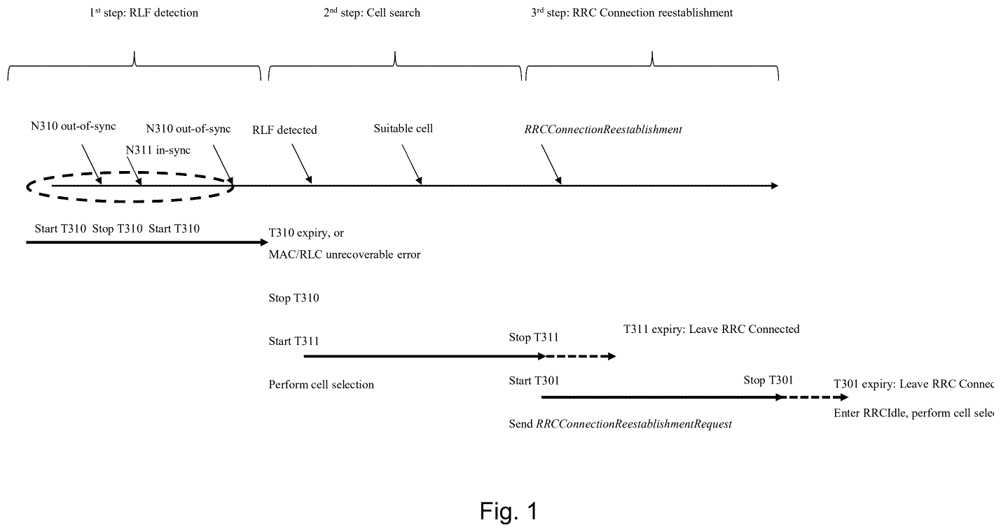

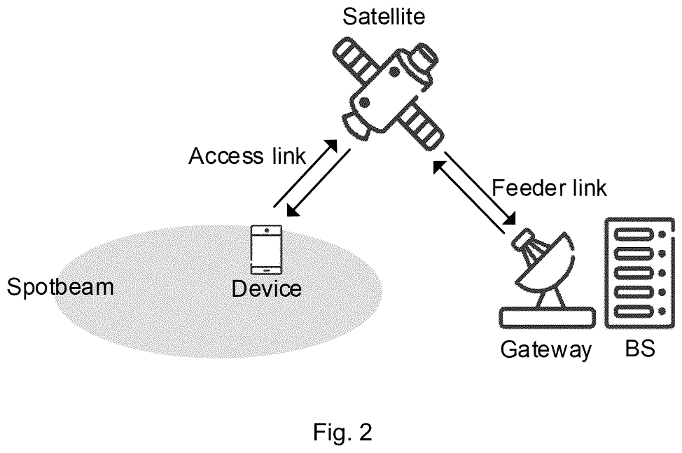

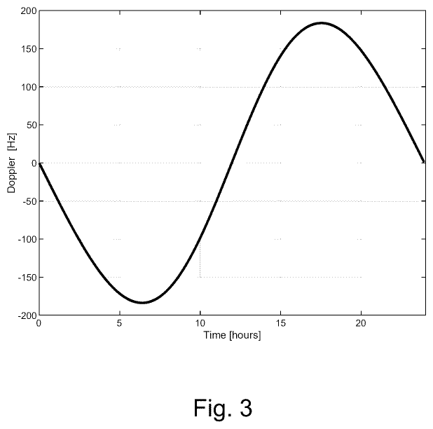

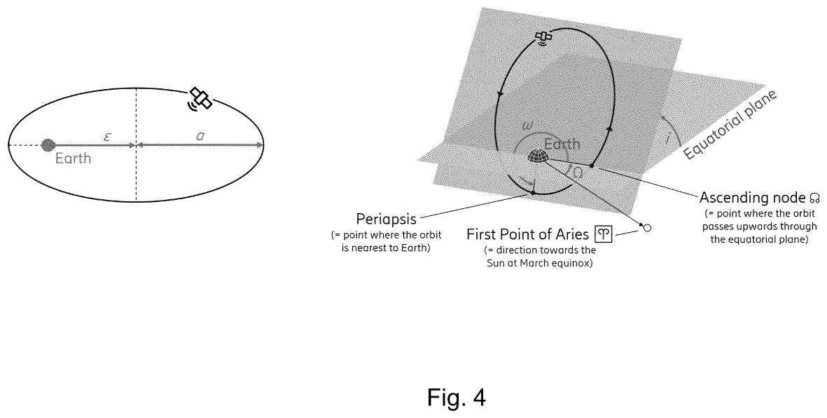

### DETAILED DESCRIPTION

As described above, certain challenges currently exist when evolving cellular Internet-of-things (IoT) technologies, such as enhanced machine type communication (eMTC) and narrowband IoT (NB-IoT), to support non-terrestrial networks (NTNs). Certain aspects of the present disclosure and their embodiments may provide solutions to these or other challenges. Particular embodiments reduce the time taken to declare radio link failure (RLF) in IoT non-terrestrial networks. Particular embodiments provide information to the user equipment (UE) (e.g., guidance regarding when to declare RLF) so that radio link failure can be declared earlier when the UE is not expected to get back in-sync. The overall service interruption is shorter when compared to legacy operation.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The embodiments outlined below are described mainly in terms of long term evolution (LTE) based (including IoT) NTNs, but they are equally applicable in a NTN based on new radio (NR) (including IoT) technology.

The term “network” may be used to refer to a network node, which typically will be an eNB (e.g., in a LTE based NTN), but may also be a gNB (e.g., in a NR-based NTN), or a base station or an access point in another type of network, or any other network node with the ability to directly or indirectly communicate with a UE.

Global Navigation Satellite Systems (GNSS) play a role in particular embodiments. The most well-known is the American Global Positioning System (GPS), but there are also other also other similar systems which could provide the functionality utilized in the proposed solution, e.g., the Russian Global Navigation Satellite System (GLONASS), the Chinese BeiDou Navigation Satellite System and the European Galileo.

The terms “idle mode” and “RRC_IDLE state” are used interchangeably herein.

A frequently used expression, or concept, in some embodiments is “expected time to be served.” Equivalent expressions for the same concept include “expected time to be served with sufficient channel quality.” “expected time to be served with sufficiently good channel quality.” “expected time to be covered.” “expected time to be covered with sufficient channel quality.” “expected time to be covered with sufficiently good channel quality.” “expected coverage time.” “expected coverage time with sufficient channel quality.” and “expected coverage time with sufficiently good channel quality.” In these expressions, “sufficient channel quality” and “sufficiently good channel quality” may refer to a channel quality that exceeds one or more threshold value(s), e.g. related to a UE's perceived RSRP, RSRQ, SINR or RSSI (or a pathloss threshold which the UE's experienced or estimated pathloss should be below for the channel quality to be sufficient or sufficiently good).

For convenience, the term “satellite” may often be used even when a more appropriate term would be “gNB associated with the satellite.” Here, a gNB associated with a satellite may include both a regenerative satellite, where the gNB is the satellite payload, the gNB is integrated with the satellite, or a transparent satellite, where the satellite payload is a relay and gNB is on the ground (i.e., the satellite relays the communication between the gNB on the ground and the UE).

The term signal or radio signal used herein can be any physical signal or physical channel. Examples of downlink physical signals are reference signal (RS) such as NPSS. NSSS, NRS, CSI-RS. DMRS, signals in SSB, DRS, CRS, PRS etc. Examples of uplink physical signals are reference signal such as SRS, DMRS, etc. The term physical channel refers to any channel carrying higher layer information, e.g. data, control, etc. Examples of physical channels are PBCH, NPBCH, PDCCH, PDSCH, MPDCCH, NPDCCH, NPDSCH, E-PDCCH, PUSCH, PUCCH, NPUSCH, etc.

The term carrier frequency used herein refers to a frequency of a cell which can be a serving cell or a non-serving cell. In time division duplex (TDD), the same carrier frequency is used in uplink and downlink for the same cell. In frequency division duplex (FDD) or half-duplex FDD (HD-FDD), different carrier frequencies are used in uplink and downlink for the same cell. One or a plurality of cells can operate on the same carrier frequency. The carrier frequency may also be referred to as simply a carrier, frequency, frequency channel, radio channel, etc. The carrier frequency may be indicated or signaled by the network to the UE or by the UE to network (e.g., with measurement results) by a carrier frequency number or identifier or radio channel number or identifier called as ARFCN or EARFCN etc. There is separate ARFCN or EARFCN for uplink and downlink in FDD or HD-FDD.

The UE performs measurements on one or more reference signal (RS) transmitted in a cell, which can be serving cell or neighbour cell. The measured cell can operate on or belong to the serving carrier frequency (e.g., an intra-frequency carrier) or it can operate on or belong to the non-serving carrier frequency (e.g., an inter-frequency carrier, inter-RAT carrier, etc). Examples of RS are given above. Examples of measurements are cell identification (e.g., PCI acquisition, cell detection), Reference Symbol Received Power (RSRP), Reference Symbol Received Quality (RSRQ), secondary synchronization RSRP (SS-RSRP), narrowband RSRP (NRSRP), narrowband RSRQ (NRSRQ), SS-RSRQ, SINR, RS-SINR, SS-SINR, CSI-RSRP, CSI-RSRQ, acquisition of system information (SI), cell global ID (CGI) acquisition, Reference Signal Time Difference (RSTD), UE RX-TX time difference measurement, Radio Link Monitoring (RLM), which consists of Out of Synchronization (out of sync) detection and In Synchronization (in-sync) detection etc. CSI measurements performed by the UE are used for scheduling, link adaptation etc. by the network. Examples of CSI measurements or CSI reports are CQI, PMI, RI, etc. They may be performed on reference signals like CRS, CSI-RS or DMRS.

The term measurement occasion (MO) as used herein comprises any time instance or time duration over which the UE can perform one or more measurements on signals of one or more cells. MO may be expressed in terms of a duration, e.g. X1 seconds or ms, X2 number of time resources. The MO may occur periodically or aperiodically. The MO may also be referred to as measurement opportunity, measurement resources, measurement instances, etc.

The term serving cell inactive time resources used herein may also be referred to as inactive time resources or inactive resources. During the inactive time resources, the UE is not expected to operate signals in the serving cell. A UE operating a signal in a serving cell comprises receiving a signal and/or transmitting a signal in the serving cell. More specifically, during the inactive time resources the UE is not expected to be scheduled for receiving and/or transmitting signals in the serving cell. During active time resources, the UE can be scheduled in the serving cell. Examples of inactive time resources are discontinuous reception (DRX) inactive time, invalid time resources (ITR), uplink gaps for downlink synchronization, etc. The inactive time resource may also be referred to as inactive time period, inactive time duration, inactive time occasion, etc.

The term invalid time resource (ITR) used herein refers to a length of time or one or a plurality of time resources (e.g., slots, subframes, etc.) over which the UE is not expected to be scheduled even if they fully or partially overlap in time with DRX active time. Examples of ITR include one or more of: unused subframes between uplink and downlink in HD-FDD when switching between uplink and downlink, subframes occurring between control channel search spaces (e.g., between NPDCCH reception occasions), or subframes not indicated in ‘NB-IoT DL subframe’ bitmap configured by the network, etc.

Particular embodiments include RLF detection. In LTE, radio link monitoring (RLM) is carried out by a UE performing measurement on downlink reference symbols (CRS) in RRC_CONNECTED state. If results of radio link monitoring include a certain number of consecutive out of sync (OOS) indications, the UE starts the RLF procedure and declares radio link failure (RLF) after the expiry of RLF timer, i.e., T310. This ensures that out of sync indications are not due to a temporary degradation in the channel, e.g., a temporary obstacle blocking the signal etc., so that an unnecessary attempt to re-establish the RRC connection and service interruption can be avoided.

In a terrestrial network, a UE would not typically know whether the experienced degradation in channel quality is due to being close to a cell border. However, in a NTN, such information can be (at least implicitly) available to the UE, for example, via ephemeris data, minimum elevation angle to the serving satellite, etc.

In one embodiment, the number of consecutive out of sync (OOS) indications (and/or the number of consecutive in-sync (IS) indications) is scaled in the UE with respect to the time left prior to a service link or feeder link switch which may be indicated by, but not limited to, expected time to be served, elevation angle to the serving satellite, distance to a reference point such as the center of the serving cell, etc. The UE may determine such using the ephemeris data, GNSS receiver, etc., but in a variant a timer or absolute time, e.g., configured by the network, may also be used, when configured by the network, where it applies. The relevant criteria and the scaling factor can be provided via system information broadcast or dedicated signaling. The scaling may be realized by scaling the number of consecutive OOS/IS indications the UE counts (e.g., 4 counted indications may be scaled to 6) or, alternatively, the N310/N311 values to compare the counted OSS/IS indications with may be scaled (e.g., reduced).

In some embodiments, the scaling consists of a single or multiple step function(s) where the eNB provides a set of satellite elevation angles (or other metrics such as distance to a reference point, expected time to be served (e.g., time until a cell/service link/feeder link switch), etc.) dependent OOS indication thresholds (and/or IS indication thresholds). As an example, the eNB provides one threshold for above 50 degrees elevation angle and one threshold for below 50 degrees elevation angle. When the UE operates at above 50 degrees elevation, the number of consecutive OOS indications is threshold1 and when it operates at below 50 degrees elevation angle threshold2 is utilized (and similar multiple thresholds may be configured for the number of consecutive IS indications too).

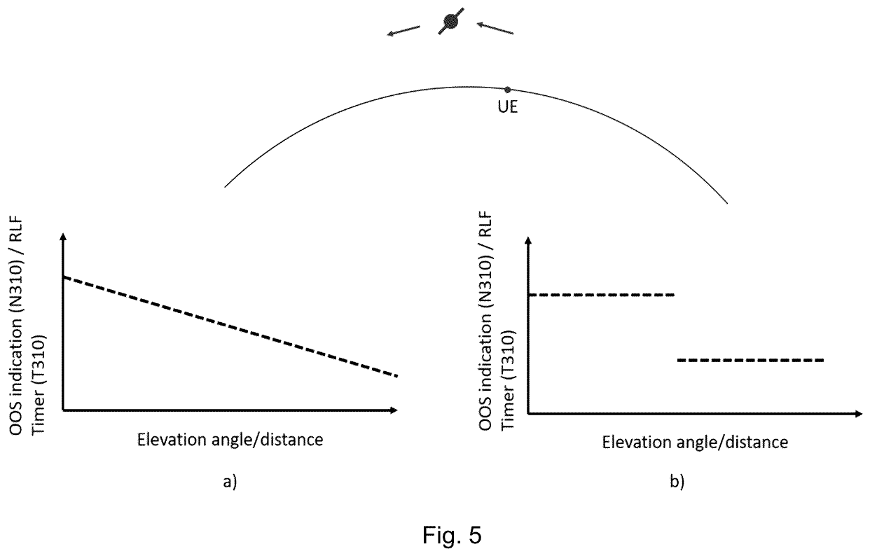

FIG. 5 illustrates the general concept along with an embodiment using scaling. The satellite elevation angle the UE uses to determine the scaling may, as one option, be the satellite's elevation angle as seen from the UE's current position (or the UE's position projected on the WGS 84 ellipsoid), or, as another option, the satellite elevation angle the UE uses may be the satellite's elevation angle as seen from a configured reference point, e.g., a reference point representing the center of the cell. The former has the advantage that it relates directly to the UE's current conditions (i.e., the satellite elevation angle experienced by the UE), while the latter has the advantage that it will be the same in the entire cell and all UE's that employ the scaling mechanism in the cell will do so consistently, which is beneficial, e.g., when cell switches occur in earth fixed beam scenarios.

Another example realization of the scaling of the number of consecutive OSS indications and/or IS indications, and/or the scaling of the threshold values N310 and/or N311 is that the scaling factor is a direction function of time. The function can be continuous or discrete.

The scaling of OOS indications and the scaling of IS indications do not have to be the same. For example, as the elevation angle of the serving satellite becomes lower, the number of OSS indications may be scaled down to a smaller value while the number of IS indications may be scaled up to a larger value. This would accelerate the time taken to declare RLF. Similarly, the scaling of the threshold value N310 can be different from that of N311.

In some embodiments, the value of the RLF timer is scaled with respect to the time left prior to a service link or feeder link switch which may be indicated by, but not limited to, expected time to be served, elevation angle to the serving satellite, distance to a reference point such as the center of the serving cell etc. In a variant, a new timer can be derived based on the scaled RLF timer. The relevant criteria/configuration and the scaling factor can be provided via system information broadcast or dedicated signaling, e.g., an RRCReconfiguration message.

Similarly, the above embodiment may be implemented by signaling multiple RLF timer values and activating them at different elevation angles (or other metrics such as distance to reference point, expected time to be served (e.g., time until a cell/service link/feeder link switch), etc.). That is, the different RLF timer values are associated with different metric values and the UE activates them autonomously in accordance with this configuration.

Another example realization of the scaling of the RLF timer is that the scaling factor is a direct function of time (e.g., linear scaling). The function can be continuous or discrete.

An example ASN.1 specification of multiple RLF and OOS indications with a single elevation angle threshold can be seen below:

The IE UE-TimersAndConstants contains timers and constants used by the UE in either RRC_CONNECTED or RRC_IDLE.

UE-TimersAndConstants information element

-- ASN1START

| | |
|---|---|
| UE-TimersAndConstants ::= | SEQUENCE { |
| t300 | ENUMERATED { |
| | ms100, ms200, ms300, ms400, ms600, ms1000, ms1500, |
| | ms2000}, |
| t301 | ENUMERATED { |
| | ms100, ms200, ms300, ms400, ms600, ms1000, ms1500, |
| | ms2000}, |
| t310 | ENUMERATED { |
| | ms0, ms50, ms100, ms200, ms500, ms1000, ms2000}, |
| n310 | ENUMERATED { |
| | n1, n2, n3, n4, n6, n8, n10, n20}, |
| t311 | ENUMERATED { |
| | ms1000, ms3000, ms5000, ms10000, ms15000, |
| | ms20000, ms30000}, |
| n311 | ENUMERATED { |
| | n1, n2, n3, n4, n5, n6, n8, n10}, |

...,

| | |
|---|---|
| [[ t300-v1310 | ENUMERATED { |
| | ms2500, ms3000, ms3500, ms4000, ms5000, ms6000, |

ms8000,

| | |
|---|---|
| ms10000} | OPTIONAL, -- Need OR |

| | |
|---|---|
| t301-v1310 | ENUMERATED { |
| | ms2500, ms3000, ms3500, ms4000, ms5000, ms6000, |

ms8000,

| | |
|---|---|
| ms10000} | OPTIONAL -- Need OR |

]],

| | |
|---|---|
| ]] t310-v1330 | ENUMERATED {ms4000, ms6000} |

OPTIONAL -- Need OR

]],

| | |
|---|---|
| [[ t300-r15 | ENUMERATED {ms4000, ms6000, ms8000, ms10000, ms15000, |
| | ms25000, ms40000, ms60000} OPTIONAL -- |

Cond EDTorPUR
]],

| | |
|---|---|
| ntn-EarlyRLF | SEQUENCE { |
| first-n310 | ENUMERATED { |
| | n1, n2, n3, n4, n6, n8, n10, n20}, |
| first-t310 | ENUMERATED { |
| | ms0, ms50, ms100, ms200, ms500, ms1000, |
| | ms2000}, |
| second-n310 | ENUMERATED { |
| | n1, n2, n3, n4, n6, n8, n10, n20}, |
| second-t310 | ENUMERATED { |
| | ms0, ms50, ms100, ms200, ms500, ms1000, |
| | ms2000}, |
| elevationAngleThreshold | ENUMERATED { |
| | 10deg, 20deg, 30deg, 40deg, 50deg, 60deg, |
| | 70deg, 80deg} |
| | } |

]],
}
-- ASN1STOP

In some embodiments, regardless of the configured OOS or IS (N310, N311), the UE starts the T310 timer when a time “Tservice” (e.g., reflecting the expected time to be served) reaches (or goes below) a fixed or configured value that may be 0. Tservice marks the time when the serving cell is stopping to serve the area and it may be expressed in some other form than absolute time. For example, Tservice may be realized as a timer counting the time downwards to 0, where the timer value 0 indicates the point when the serving cell stops serving the area. With such a timer, the UE may be configured to start the T310 timer when the Tservice timer goes below a threshold, irrespective of the current values of N310 and N311).

In some embodiments, RLF is triggered directly when the serving cell is stopping to serve the area, that is when Tservice reaches a fixed or configured value that may be 0. In another variant, the UE is configured to declare RLF when the Tservice timer indicates that the expected time to be served (e.g., the time until the service cell stops serving the area) goes below a threshold.

In some embodiments, the above described scaling of the number of consecutive OOS (and/or IS) indications and/or the RLF timer may be used in combination with time-based triggering of RLF declaration. With this embodiment, the scaling makes RLF declaration increasingly more likely as the expected time to be served decreases, but if the UE has still not declared RLF when the expected time to be served goes below a threshold, the UE declares RLF, irrespective of the values of the OOS counter and/or IS counter and/or the RLF timer.

Some embodiments leverage the overlap period between the old and the new cell during cell switch in an earth fixed beam deployment. In some embodiments, the overlap period between a new and an old cell covering the same area during a cell switch in an earth fixed beams deployment case is leveraged to activate special rules, procedures and/or parameters or parameter values (e.g., scaled parameter values) related to RLF detection/declaration.

The network, e.g. a serving gNB, may configure a UE with these rules, procedures and/or parameters or parameter values when the overlap period has started or proactively at an earlier occasion before the overlap period has started. If configured before the overlap period starts, the network may activate them (e.g., using RRC or MAC signaling) when the overlap period starts. Alternatively, the UE may autonomously activate this configuration when the overlap period starts. The configuration may be conveyed to the UE using the broadcast system information or using dedicated signaling, e.g. RRC signaling, for example using an RRCReconfiguration message.

The special configuration to be applied during the overlap period may, e.g., comprise any of: (a) triggering of immediate RLF detection/declaration; (b) setting N310=0 or a scaled down value; setting T310=0 or a scaled down value; triggering of RLF detection/declaration at a random time during the overlap period; and/or triggering of RLF detection/declaration at a specific time during the overlap period.

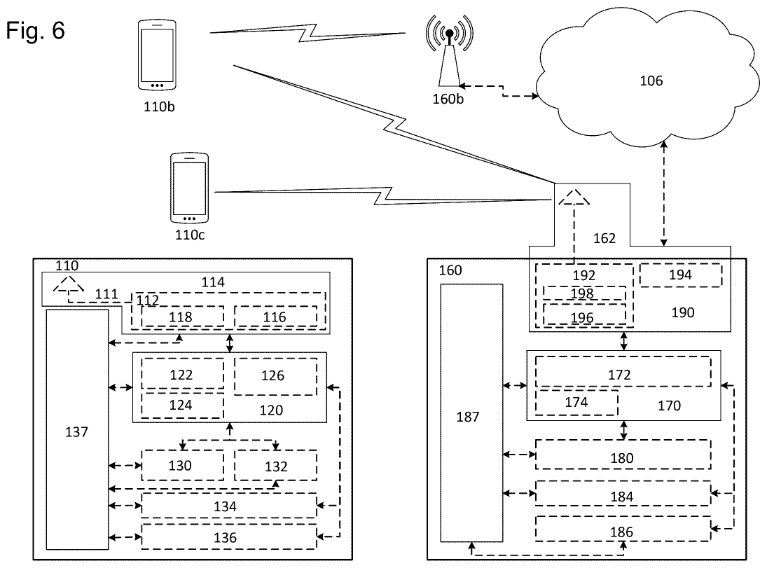

FIG. 6 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 160 includes processing circuitry 170, device readable medium 180, interface 190, auxiliary equipment 184, power source 186, power circuitry 187, and antenna 162. Although network node 160 illustrated in the example wireless network of FIG. 6 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 6 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

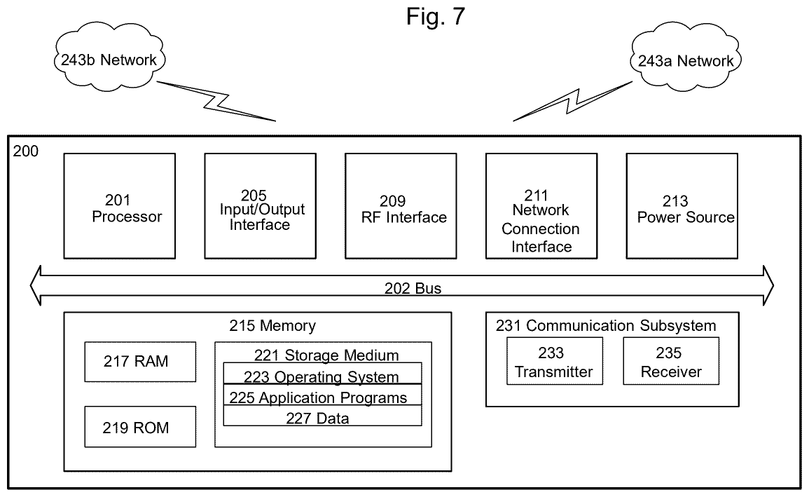

FIG. 7 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 7, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may use all the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7. RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP. SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 7, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA. WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

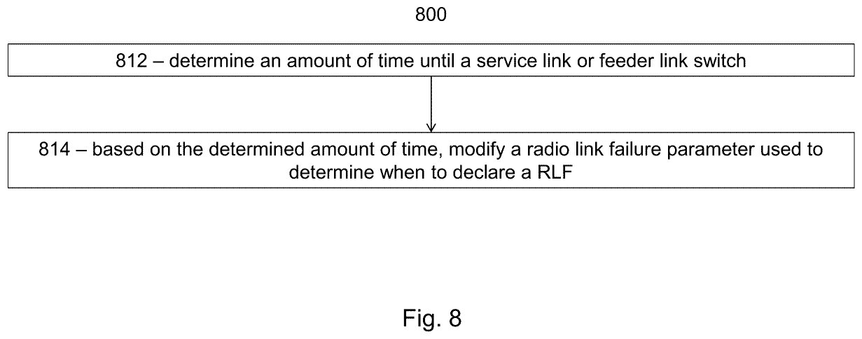

FIG. 8 is a flowchart illustrating an example method in a wireless device, according to certain embodiments. In particular embodiments, one or more steps of FIG. 8 may be performed by wireless device 110 described with respect to FIG. 6. The wireless device is capable of operating in an NTN.

The method begins at step 812, where the wireless device (e.g., wireless device 110) determines an amount of time until a service link or feeder link switch. In particular embodiments, determining the amount of time until a service link or feeder link switch is based on an elevation angle of a satellite associated with the service link or feeder link. The elevation angle of the satellite is in relation to the wireless device and/or is in relation to a center of a cell served by the satellite.

In particular embodiments, determining the amount of time until a service link or feeder link switch is based on an expected time to be served, is based on a position of the wireless device in a cell, an/or is based on an overlap period between a first satellite and a second satellite.

In particular embodiments, the wireless device may determine the amount of time until a service link or feeder link switch according to any of the embodiments and examples described herein.

At step 814, the wireless device modifies a radio link failure parameter used to determine when to declare a RLF. In particular embodiments, modifying the radio link failure parameter comprises modifying at least one of an out of synchronization counter and an in synchronization counter, modifying a RLF timer, and/or modifying a RLF threshold.

In general, the wireless device modifies the parameters to accelerate RLF determination based on a relationship between the wireless device and a satellite. The wireless device may modify the RLF parameter according to any of the embodiments and examples described herein.

Modifications, additions, or omissions may be made to method 800 of FIG. 8. Additionally, one or more steps in the method of FIG. 8 may be performed in parallel or in any suitable order.

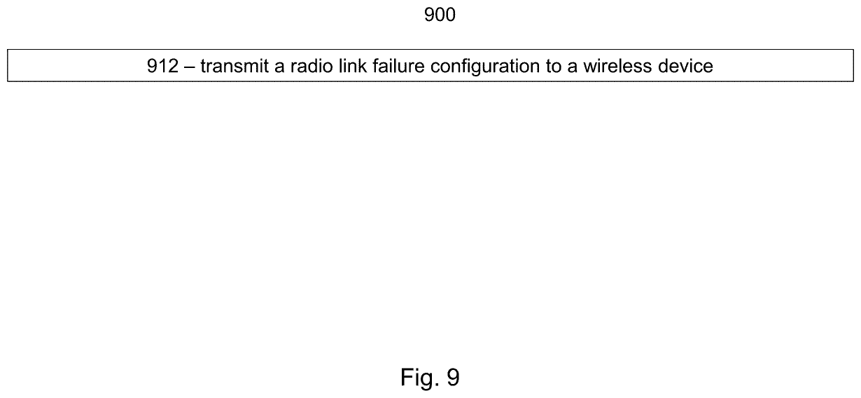

FIG. 9 is a flowchart illustrating an example method in a network node, according to certain embodiments. In particular embodiments, one or more steps of FIG. 9 may be performed by network node 160 described with respect to FIG. 6.

The method begins at step 912, where the network node (e.g., network node 160) transmits a radio link failure configuration to a wireless device. The radio link failure configuration comprises any one or more of: a threshold value representing a time until a service link or feeder link switch; a value or scaling factor for an out of synchronization counter; a value or scaling factor for an in synchronization counter; a value or scaling factor for a RLF timer; and/or a value or scaling factor for a RLF threshold.

In particular embodiments, the threshold value representing a time until a service link or feeder link switch is based on one or more of an elevation angle of a satellite, a position of the wireless device in a cell and an overlap period between a first satellite and a second satellite.

Modifications, additions, or omissions may be made to method 900 of FIG. 9. Additionally, one or more steps in the method of FIG. 9 may be performed in parallel or in any suitable order.

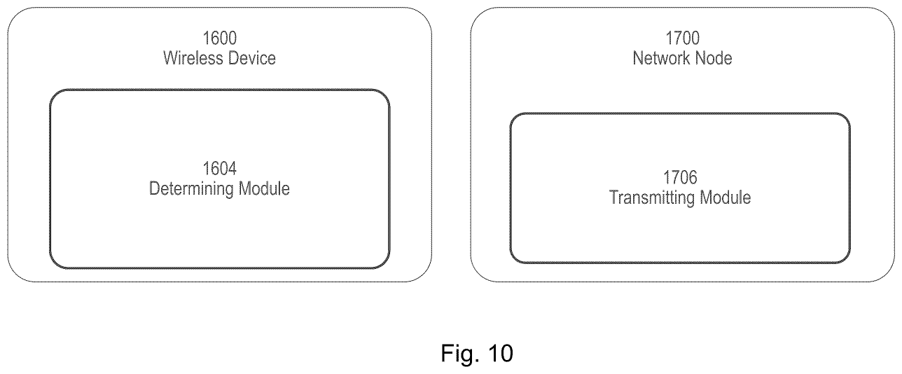

FIG. 10 illustrates a schematic block diagram of two apparatuses in a wireless network (for example, the wireless network illustrated in FIG. 6). The apparatuses include a wireless device and a network node (e.g., wireless device 110 and network node 160 illustrated in FIG. 6). Apparatuses 1600 and 1700 are operable to carry out the example methods described with reference to FIGS. 8 and 9, respectively, and possibly any other processes or methods disclosed herein. It is also to be understood that the methods of FIGS. 8 and 9 are not necessarily carried out solely by apparatus 1600 and/or apparatus 1700. At least some operations of the method can be performed by one or more other entities.

Virtual apparatuses 1600 and 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to determining module 1604, and any other suitable units of apparatus 1600 to perform corresponding functions according one or more embodiments of the present disclosure. Similarly, the processing circuitry described above may be used to cause transmitting module 1706, and any other suitable units of apparatus 1700 to perform corresponding functions according one or more embodiments of the present disclosure.

As illustrated in FIG. 10, apparatus 1600 includes determining module 1604 configured to determine an amount of time until a service link or feeder link switch and modify a RLF parameter according to any of the embodiments and examples described herein.

As illustrated in FIG. 10, apparatus 1700 includes transmitting module 1706 configured to transmit an RLF configuration to a wireless device according to any of the embodiments and examples described herein.

FIG. 11 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 11, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 18.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

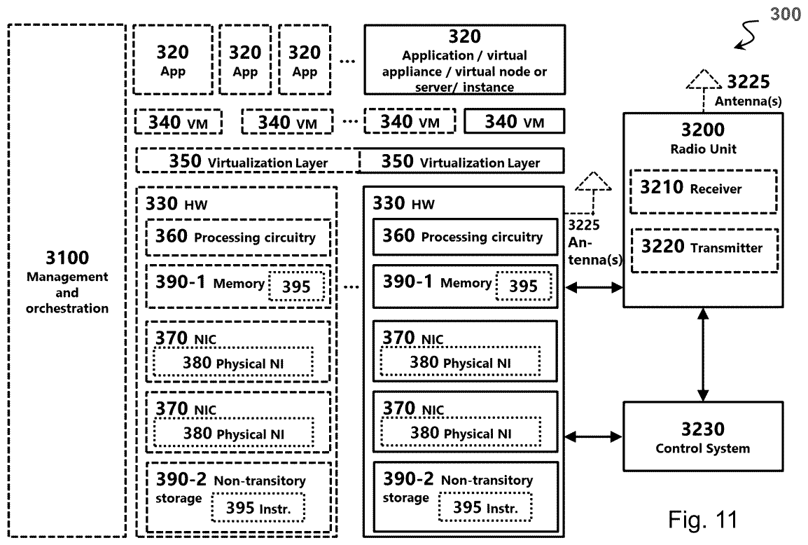

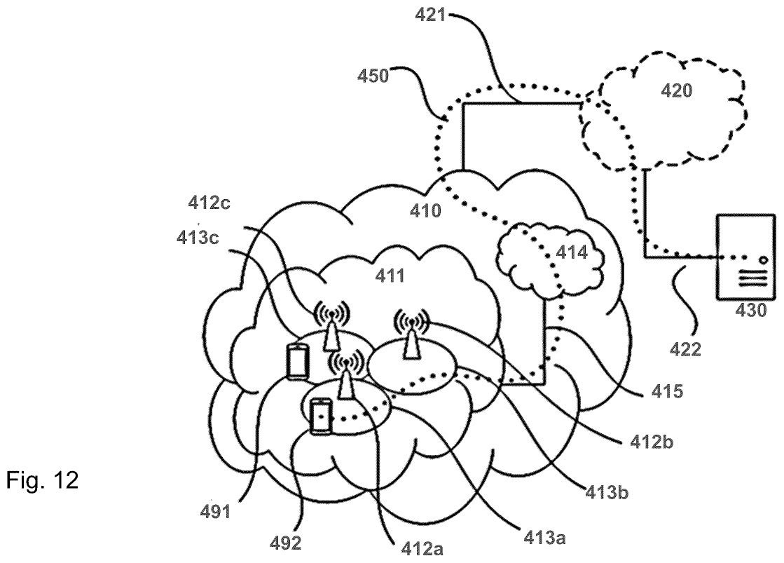

With reference to FIG. 12, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a. 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 12 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

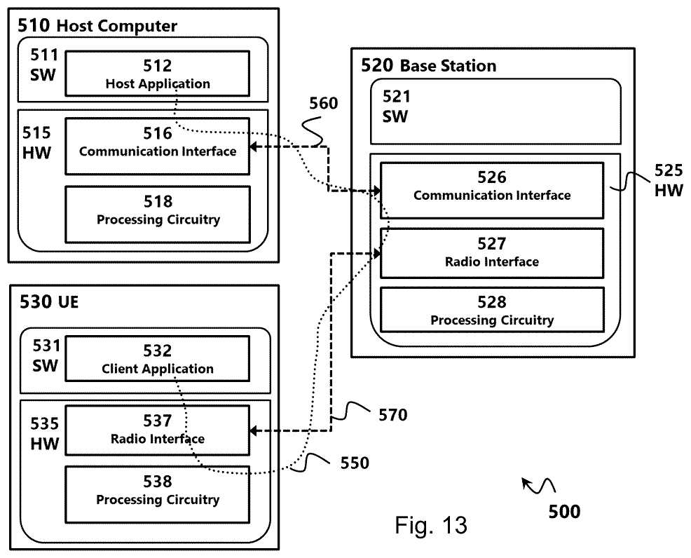

FIG. 13 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 13. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 13) served by base station 520. Communication interface 526 may be configured to facilitate connection 560 to host computer 510. Connection 560 may be direct, or it may pass through a core network (not shown in FIG. 13) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 13 may be similar or identical to host computer 430, one of base stations 412a, 412b, 412c and one of UEs 491, 492 of FIG. 6, respectively. This is to say, the inner workings of these entities may be as shown in FIG. 13 and independently, the surrounding network topology may be that of FIG. 6.

In FIG. 13, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, and thereby provide benefits such as reduced user waiting time, better responsiveness and extended battery life.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

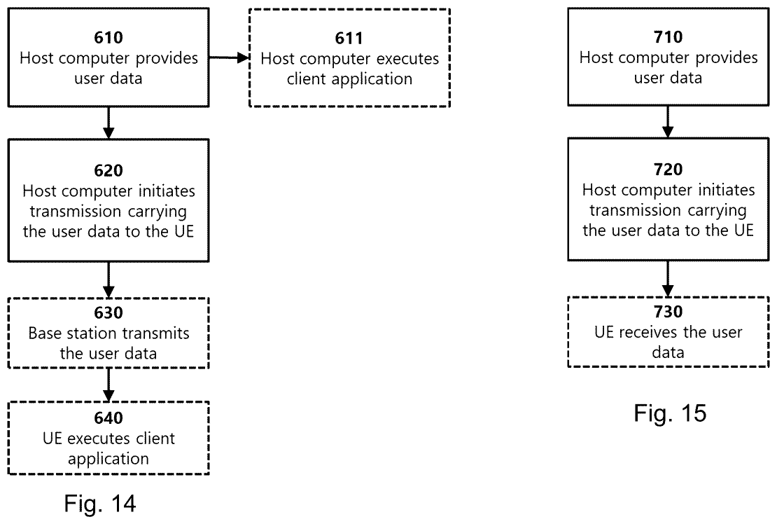

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

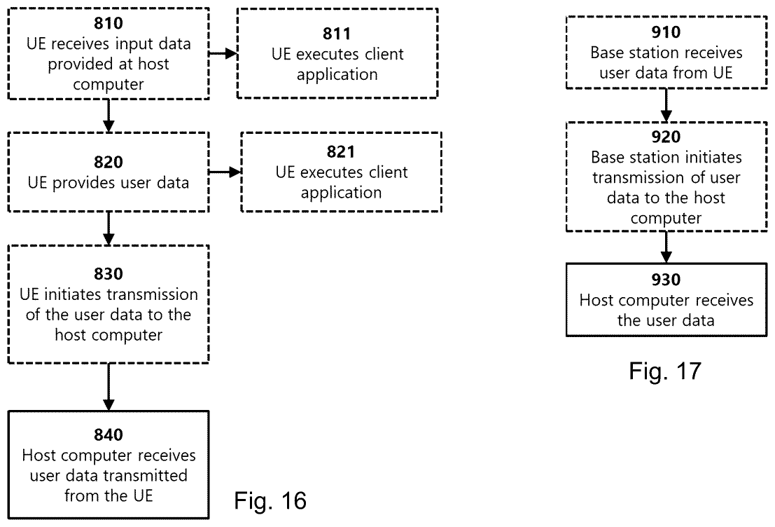

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a wireless device capable of operating in a non-terrestrial network (NTN), the method comprising:
determining an amount of time until a service link or feeder link switch; and
based on the determined amount of time, modifying a radio link failure parameter used to determine when to declare a radio link failure (RLF).

2. The method of claim 1, wherein determining the amount of time until a service link or feeder link switch is based on an elevation angle of a satellite associated with the service link or feeder link.

3. The method of claim 2, wherein the elevation angle of the satellite is in relation to the wireless device.

4. The method of claim 2, wherein the elevation angle of the satellite is in relation to a center of a cell served by the satellite.

5. The method of claim 1, wherein determining the amount of time until a service link or feeder link switch is based on an expected time to be served.

6. The method of claim 1, wherein determining the amount of time until a service link or feeder link switch is based on a position of the wireless device in a cell.

7. The method of claim 1, wherein determining the amount of time until a service link or feeder link switch is based on an overlap period between a first satellite and a second satellite.

8. The method of claim 1, wherein modifying the radio link failure parameter comprises modifying at least one of an out of synchronization counter and an in synchronization counter.

9. The method of claim 1, wherein modifying the radio link failure parameter comprises modifying a RLF timer.

10. The method of claim 1, wherein modifying the radio link failure parameter comprises modifying a RLF threshold.

11. A wireless device (110) capable of operating in a non-terrestrial network (NTN), the wireless device comprising processing circuitry (120) operable to:
determine an amount of time until a service link or feeder link switch; and
based on the determined amount of time, modify a radio link failure parameter used to determine when to declare a radio link failure (RLF).

12. The wireless device of claim 11, wherein the processing circuitry is operable to determine the amount of time until a service link or feeder link switch based on an elevation angle of a satellite associated with the service link or feeder link.

13. The wireless device of claim 12, wherein the elevation angle of the satellite is in relation to the wireless device.

14. The wireless device of claim 12, wherein the elevation angle of the satellite is in relation to a center of a cell served by the satellite.

15. The wireless device of claim 11, wherein the processing circuitry is operable to determine the amount of time until a service link or feeder link switch based on an expected time to be served.

16. The wireless device of claim 11, wherein the processing circuitry is operable to determine the amount of time until a service link or feeder link switch based on a position of the wireless device in a cell.

17. The wireless device of claim 11, wherein the processing circuitry is operable to determine the amount of time until a service link or feeder link switch based on an overlap period between a first satellite and a second satellite.

18. The wireless device of claim 11, wherein the processing circuitry is operable to modify the radio link failure parameter by modifying at least one of an out of synchronization counter and an in synchronization counter.

19. The wireless device of claim 11, wherein the processing circuitry is operable to modify the radio link failure parameter by modifying a RLF timer.

20. The wireless device of claim 21, wherein the processing circuitry is operable to modify the radio link failure parameter by modifying a RLF threshold.

21. A method performed by a network node capable of operating in a non-terrestrial network (NTN), the method comprising:
transmitting a radio link failure configuration to a wireless device, the radio link failure configuration comprising any one or more of:
a threshold value representing a time until a service link or feeder link switch;
a value or scaling factor for an out of synchronization counter;
a value or scaling factor for an in synchronization counter;
a value or scaling factor for a RLF timer; and
a value or scaling factor for a RLF threshold.

22. The method of claim 21, wherein the threshold value representing a time until a service link or feeder link switch is based on one or more of an elevation angle of a satellite, a position of the wireless device in a cell and an overlap period between a first satellite and a second satellite.

23. A network node capable of operating in a non-terrestrial network (NTN), the network node comprising processing circuitry operable to:
transmit a radio link failure configuration to a wireless device, the radio link failure configuration comprising any one or more of:
a threshold value representing a time until a service link or feeder link switch;
a value or scaling factor for an out of synchronization counter;
a value or scaling factor for an in synchronization counter;
a value or scaling factor for a RLF timer; and
a value or scaling factor for a RLF threshold.

24. The network node of claim 23, wherein the threshold value representing a time until a service link or feeder link switch is based on one or more of an elevation angle of a satellite, a position of the wireless device in a cell and an overlap period between a first satellite and a second satellite.
